(19) United States
(12) Patent Application Publication
(10) Pub. No.: US 2021/0176975 A1
(43) Pub. Date: Jun. 17, 2021

(54) Bug Fan

(71) Applicant: William Walker, Fairburn, GA (US)

(72) Inventor: William Walker, Fairburn, GA (US)

(21) Appl. No.: 16/920,041

(22) Filed: Jul. 2, 2020

Related U.S. Application Data
(60) Provisional application No. 62/974,572, filed on Dec. 12, 2019.

(51) Int. Cl. A01M 1/06; A01M 1/10

(52) U.S. Cl. CPC A01M 1/06; A01M 2200/012; A01M 1/106

(57) ABSTRACT

The device is a fan, similar to a typical rotary desk fan, but with the motor running in reverse to create inward airflow. An insect screen lines the rear of the blade housing ana a hinged door is located at the bottom of the housing. A small cup is mounted to the front of the fan to hold insect attractant.

When the insect approaches the attractant, it is drawn into the inward airflow and into the fan housing. Because the rear of the housing is lined with fine mesh screening, the insect cannot escape and will eventually die of dehydration. The hinged door at the bottom of the housing allows convenient removal of accumulated dead insects.

### BRIEF SUMMARY OF INVENTION

This device is intended to capture and kill nuisance insects.

The device is a fan, similar to a typical rotary desk fan, but with the motor running in reverse to create inward airflow. An insect screen lines the rear of the blade housing and a hinged door is located at the bottom of the housing. A small cup is mounted to the front of the fan to hold insect attractant.

When the insect approaches the attractant, it is drawn into the inward airflow and into the fan housing. Because the rear of the housing is lined with fine mesh screening, the insect cannot escape and will eventually die of dehydration. The hinged door at the bottom of the housing allows convenient removal of accumulated dead insects.

### DESCRIPTION OF DRAWING VIEWS

FIG. 1: Front and Side View

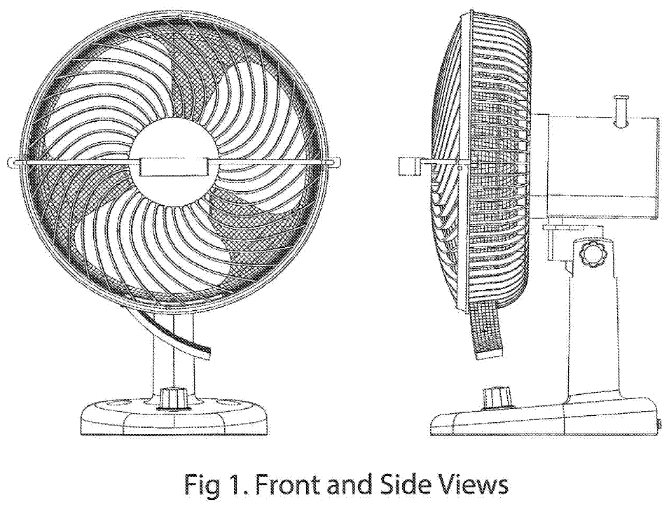

FIG. 2: Isometric Views and Component Identification

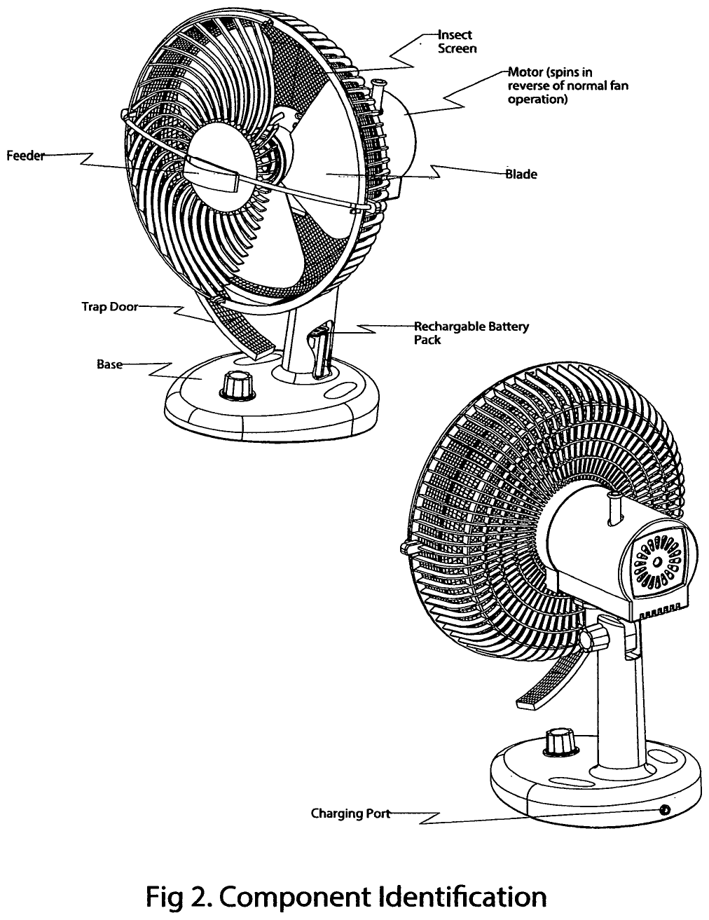

FIG. 3: Exploded Views

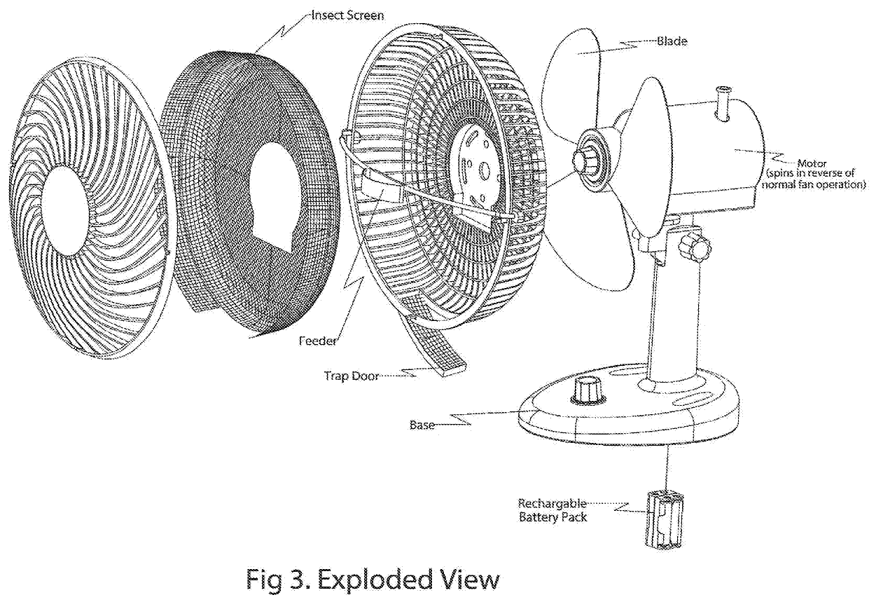

I claim:

1. A Portable bug trapping device comprising:
A pedestal desk fan like structure which is further comprising a base, a switch to turn on and turn off the fan motor and for the speed control of the same fan motor, a charging port at the backside of the base for charging the batteries and running the device simultaneously by external power supply means;
A vertical housing is connected to the base for mounting the fan motor and the fan case, containing the space for the removable and rechargeable batteries;
A fan with the plurality of blades directly connected with motor, which moves at backward direction to create reverse airflow for the suction of the insects from front side;
A fine mesh fixed behind the fan, is made of either metal or plastic for the insects trapping and collection means and stopping the insects from escaping the device;
A Fan case which is comprising a front and a back housing around the fan for the safety of user said front housing is also comprising a handle for means of carrying the device;
A removable insect attractant cup mounted in the middle of the said front housing of the fan to release the insect's attractant chemicals like pheromones to attract the insects toward the device.

2. A bug trap as claimed in claim 1, attracts the insects and bugs by releasing the insect attractant chemicals like pheromones in the air when the insects fly towards the device the strong suction of the air created by the fan sucks the insects and throws them towards the said mesh as claimed in claim 1, because of compression of airflow insects cannot move or escape through the mesh and due to continuous flow of the air insects get killed by the dehydration.

3. The Bug trapping device in claim 1, the said back fan housing of the bug trapping device comprises a hinged door at the bottom side for removing dead insects out of the bug trap device to keep the device clean.

4. A vertical housing connected to the base as claimed in claim 1 also comprises the measure to control the pitch i.e. swivel motion of the fan case.
